(19) United States
(12) Patent Application Publication
(10) Pub. No.: US 2007/0193137 A1
(43) Pub. Date: Aug. 23, 2007

(54) Adjustable fail safe hurricane screen

(76) Inventor: Robert T. DeBoth, Bradenton, FL (US)

Correspondence Address: Donald W. Meeker;Patent Agent, 924 East Ocean Front #E, Newport Beach, CA, 92661, US

(21) Appl. No.: 11/705,676

(22) Filed: Feb. 13, 2007

Related U.S. Application Data
(60) Provisional application No. 60/772,554, filed on Feb. 13, 2006.

(51) Int. Cl. E06B 3/26

(52) U.S. Cl. 52/202

(57) ABSTRACT

Buckles attach to an interior portion on a front surface of the hurricane screen in opposing pairs around the screen. Straps attach on the hemmed edge on the back surface aligned with the buckles. Each strap loops through an anchor and into the buckle to adjust the tension of the strap. The anchor slips over a pre-attached fastener and tightens on the fastener when the belt is tensioned.

### CROSS-REFERENCE TO RELATED APPLICATIONS

This application claims the benefit of U.S. Provisional Patent Application No. 60/772,554 filed Feb. 13, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to a wind abatement screen attachment system for covering openings such as windows and doors in a building and particularly to an easily installed heavy-duty screen assembly that is failsafe and resistant to hurricane force winds and windborne flying debris; the screen assembly comprising a removable, flexible, heavy-duty screen which rolls or folds up for storage, the screen having a plurality straps each with one end affixed to an inner edge thereof and the other end run through an anchor bracket and an adjustable buckle and affixed to a center portion of the screen on an outer side, the screen being removably secured by hooking each anchor over a protruding screw pre-attached to the building or adjacent to the building and tightening the screw and tightening the straps, a quick and easy installation that can be carried out by a single person to secure the building for an impending storm.

2. Description of Related Art Including Information Disclosed Under 37 CFR 1.97 and 1.98

High-velocity winds are potentially destructive to buildings. The path of hurricanes is often accurately predicted and homeowners are usually alerted early enough to prepare for their arrival. Residents try to protect their homes or businesses by protecting windows, doors or the like from the damaging windborne debris. To cover the openings, sheets of plywood are often nailed over the windows and/or doors. When the hurricane winds have subsided, the plywood sheets are removed. The plywood is very difficult to install and remove by a single person. Homeowners who have prefabricated removable panel-type window protection systems which require manual installation still have difficulty getting the protective devices in place. Bulky plywood sheets, corrugated sheets, or panel systems require a large amount of storage space.

In prior art screens using grommets, to install a grommets you must cut holes. This basically nullifies the tensile strength of the product and it must now rely on the “tear strength” of the material. This is why hems are folded 4× adding thickness to support this problem. Grommets have a small surface area of about .¾″. A 0.5″ grommet only pull is about 0.75″ (½ circumference of the grommet)

Most other wind protection structures that fail under extremely high wind conditions will tear apart the building to which they are attached if the wind protection structures are torn from all or some of the attaching points to the building.

The prior art devices do not adequately solve these problems.

U.S. Pat. No. 6,412,540, issued Jul. 2, 2002 to Hendee, shows a structural protective windscreen. An apparatus, a windscreen, and method are provided for securing a structure against damage from high winds, wherein the windscreen is engagable with a track with slidable, adjustable connectors such as eyebolt connectors or fixed pin connectors that is secured to the eaves or sides of a house, and, with a coarse fabric such as the sheet attached to the track with strap like elements and connectors and anchoring device for securing the windscreen to the ground preventing damage to the structure.

U.S. Pat. No. 6,161,605, issued Dec. 19, 2000 to Pena, puts forth an aesthetically-pleasing foldable, reusable security device and method for protecting double-hung windows from storm debris hazards and vandalism, wherein the perimeter edges of the device fit within the outermost groove of a double-hung window frame and can be easily installed and removed by one adult of ordinary strength and coordination standing behind the window. The device also protects the building against unauthorized entry and burglary, and is particularly useful for protecting upstairs windows since it requires no pre-installation steps or hardware, no professional installation, no tools, no ladder, and its installation does not permanently alter or damage the window or adjacent building surfaces. The device has at least two protective panels with two or more hinges attached between the front surfaces of adjacent panels which allow them to fold substantially parallel to one another in a compact configuration for storage, and unfold again into an essentially planar configuration for use. Straps are attached to the back surfaces of the two endmost panels, drawn around the window sashes and secured by them against the outer window frame, and then pulled taut behind the closed and locked sashes with a quick-release fastener. The protective panels may be transparent, translucent, or opaque, depending on the homeowner's preference or need, and the straps and panels can be color coordinated and can comprise decorative designs for enhanced aesthetic appeal. Also, the panels may optionally contain reinforcing bars, resilient edging and bullet-proof materials, one-way heat transfer materials, corrosion-resistant films, and multiple-layered panel construction.

U.S. Pat. No. 6,325,085, issued Dec. 4, 2001 to Gower, claims a flexible protective system to prevent penetration of wind borne missiles. Flexible material is included within a structure to prevent wind borne missiles or debris from penetrating the confines of the structure. The flexible material may be included within the confines of a building in a free standing form or incorporating one or more interior walls of the building or structure. The flexible material may be attached to the exterior of a structure to cover openings in the structure.

U.S. Patent Application #20060207191, published Sep. 21, 2006 by Sutton, claims a protecting and reinforcing device for a building that includes a reinforcing mesh, anchors, and tensioning members. The anchors can be attached to the building or located remotely from the building. The tensioning members are for connecting the reinforcing mesh to the anchors. The tensioning members can be elastic tensioning members. A winching mechanism, for example a ratcheting strap or a come along winch could be used to tighten the reinforcing mesh, or multiple reinforcing meshes around a building and specifically around overhangs and offsets on the building.

U.S. Pat. No. 5,791,090, issued Aug. 11, 1998 to Gitlin, describes a variable tension roofing and structural protective harness for securing a structure and its roof against damage from high winds. A harness of a plurality of strap-like elements runs from or over the roof of a structure to anchors in the ground, with a coarse fabric such as shadecloth attached to and running between the strap-like elements. As the wind velocity increases, the wind pressure against the shadecloth in the area between the eaves of the roof and the ground increases, thus increasing the downward tension on the harness and further securing the roof and structure against damage.

Two U.S. Pat. No. 6,865,852 issued Mar. 15, 2005 and U.S. Pat. No. 6,176,050 issued Jan. 23, 2001 to Gower, are for a flexible wind abatement system for protection of property against high winds comprising a flexible material of predetermined strength and stretch characteristics, and in the form of a panel or several panels, utilized to protect the side of a structure including its windows and doors from the strong winds and debris impacts occurring during a hurricane. The device is anchored in a manner to space it out from the area being protected according to formula provided, and can safely dissipate substantial impacting energy. The preferred embodiment attaches to an overhanging eave and the ground below protecting in addition to the windows and doors, plantings, outdoor furniture, decorative shutters, downspouts, and such as are enclosed behind the barrier. Several methods of storage and deployment of said curtain are described including rolling, sliding, and converting to awning. The barrier has the added feature of acting as a tie down in certain applications.

U.S. Pat. No. 5,579,794, issued Dec. 3, 1996 to Sporta, discloses an apparatus and method for shielding, anchoring and containing an object such as a trailer or motor home in gale-force winds. A wind-permeable perforate sheet extends downwardly and outwardly from the top of the object or the roof of a home at an acute angle so as to surround a substantial portion of each of the sides with an inclined wind-permeable planar surface. The sheet is anchored to helical ground anchors via mechanical attachments which may also be used to tighten the sheet over the object or home. Apparatus for shielding, anchoring and containing an object such as a trailer or motor home in gale-force winds is also disclosed.

U.S. Pat. No. 6,658,801, issued Dec. 9, 2003 to Kilduff, indicates a portable fire curtain system to provide a cloak to cover a vented opening. When deployed, the curtain system will alleviate the incoming wind which is fueling the fire. The fire curtain is made of one sheet of a fire resistant or fire proof material that is folded and sewn together. Encapsulated within the fire curtain are 6 bars of high-tempered aluminum running laterally. Each corner of the fire curtain has holes that are drilled through the top and bottom bars. Four 5 foot cable leaders with loops, (one to each corner) will be secured to these holes. Two 40 foot ropes with snaps on all ends will be connected to these cable leaders to be used in the deployment. The ropes are packed in two rope deployment bags in order to prevent the ropes from tangling.

What is needed is a fail-safe adjustable fabric hurricane screen which enables tightening the “core/center” and edge of the screen creating the screen surface to a uniformed taught state to increase the ability to deflect higher wind loads and larger air born objects while avoiding shrinkage, expansion, and misfitting issues and to enable a fail-safe situation wherein the screen will fail before the anchors attached to the building so that the screen will not damage the building under extreme wind conditions.

### BRIEF SUMMARY OF THE INVENTION

An object of the present invention is to provide a fail-safe adjustable fabric hurricane screen which enables tightening the “core/center” and edge of the screen creating the screen surface to a uniformed taught state to increase the ability to deflect higher wind loads and larger air born objects while avoiding shrinkage, expansion, and misfitting issues and to enable a fail-safe situation wherein the screen will fail before the anchors attached to the building so that the screen will not damage the building under extreme wind conditions.

Another object of the present invention is to provide a screen material further comprising a tear resistance rating so that the screen material will tear and still perform at the designated resistance rating.

In brief, a removable, flexible, heavy-duty screen which rolls or folds up for storage, the screen having a plurality straps each with one end affixed to an inner edge thereof and the other end run through an anchor bracket and an adjustable buckle and affixed to a center portion of the screen on an outer side, the screen being removably secured by hooking each anchor over a protruding screw pre-attached to the building or adjacent to the building and tightening the screw and tightening the straps.

The fail-safe hurricane screen adjustable strap-and-buckle system of the present invention makes for quick and easy hanging while avoiding the pitfalls of the prior art grommet-and-track style mounting's “fitting problems”. The hurricane screen of the present invention is adjustable between anchoring points of the wall which eliminates the common issue of shrinkage due to heat exposure. Because the hurricane screen of the present invention is adjustable, it can offer a higher level of glass protection compared to most other hurricane screen products. The materials for the present hurricane screens have been selected for both strength and durability.

The present invention uses twenty millimeter polypropylene fabrics, and V-138 polyester and/or polytetrafluoroethylene (PTFE) threads which resist breakdown from ultraviolet rays. The present invention uses cast metal cam buckles, which do not slip like the other hurricane screens' plastic buckles. The present invention screen is self contained, needing no additional hardware to hang. No more missing track bolts and wing nuts, no more additional trips up and down the ladder to pick up dropped hardware and no more forgetting to charge the drill, in fact, no tools at all are required. The present invention use a specially designed bracket system that allows the screen to be attached to the inside of the window well, on the outside of build-outs, or over decorative shutters. These plates are low profiled and made from stainless steel for extreme durability. Present invention screens may be custom fabricated for unique openings in structures.

The present invention provides two styles of garage door screens. A four point garage door screen attaches to the three sides of the garage and then tents out an additional twelve inches to a cement driveway for maximum strength and deflection. A three point garage door screen attaches to the sides of the garage door. This model utilizes a specially fabricated buckles-and-strap system that allows an excellent level of protection and deflection against hurricanes without the need to connect to a fragile or non-supportive driveway material.

The screens of the present invention may be cascaded together to cover large openings. The screens can be cascaded in ten foot section. The screens of the present invention are much more manageable than the forty foot monsters some companies make. The present invention screens are inexpensive to fabricate and are therefore much more affordable than other storm shutters, and provide a much greater level of home defense in comparison to other hurricane screen products

The fine mesh screens of the present invention block 97% of the wind, debris, and rain and have been tested and approved by the State of Florida to prevent damage caused by winds up to about 170 mph (Hurricane Category 5).

An advantage of the present invention is that it provides screen buckle placement between the edge and “core/center” which creates a uniform taught screen.

Another advantage of the present invention is that it will be able to deflect higher wind loads.

Another advantage of the present invention is that it will be able to deflect larger wind born objects.

A further advantage of the present invention is that it provides a fail safe hurricane screen wherein the screen will fail before the anchors attached to the building so that the screen will not damage the building under extreme wind conditions.

One more advantage of the present invention is that the screen material further comprises a tear resistance rating so that the screen material will tear and still perform at the designated resistance rating.

An additional advantage of the present invention is that it provides self contained hardware eliminating lost hardware and the need for additional tools.

One more advantage of the present invention is that it provides a pre-installed strap and buckle system which allows a quicker easier installation and removal of the screen from the structure by simply hooking over pre-attached screws on the building to which the anchors from the screen.

Yet another advantage of the present invention is that it provides adjustability which compensates the screen's expansion and retraction characteristics caused by temperature differences and distortion from previous wind events.

More advantages of the present invention include:
Minimal architectural influence
Light weight, folds for storage
One person can attach screens
Excellent, tested protection
Protects from wind and rain
Shields glass
Less expensive than shutters
Good for large/oddly shaped areas
Appear transparent from inside your home
Can be opened from inside for exiting your home or garage
Great for protecting garage doors and large open areas like balconies terraces, patios, and porches
Allows light in
Can be installed by home owner
No Fitting Problems
Metal Buckles
Lighter Than other style Hurricane Shutters
Less Expensive than other Hurricane shutters.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a front elevational view of the adjustable failsafe hurricane screen of the present invention shown in alignment to mount over an opening on a building with the mounting screws pre-attached to the building;

FIG. 2 is a perspective view of the adjustable failsafe hurricane screen of the present invention shown mounted over an opening on a building and secured by the pre-attached screws on the building;

FIG. 3 is a top plan view showing a variety of anchor brackets used for different locations on a building or adjacent to a building;

FIG. 4 is a front elevational view of the screen material of the present invention having the tie down elements angled out at the corners;

FIG. 5 is a side elevational view in partial section with the screen material in section and showing a storm bar attached under the screen material across a window opening to keep the screen material away from a window pane located close to the outer face of the wall of the building;

FIG. 6 is a side elevational exploded view of the components of the storm bar of FIG. 5 aligned for assembly.

### DETAILED DESCRIPTION OF THE INVENTION

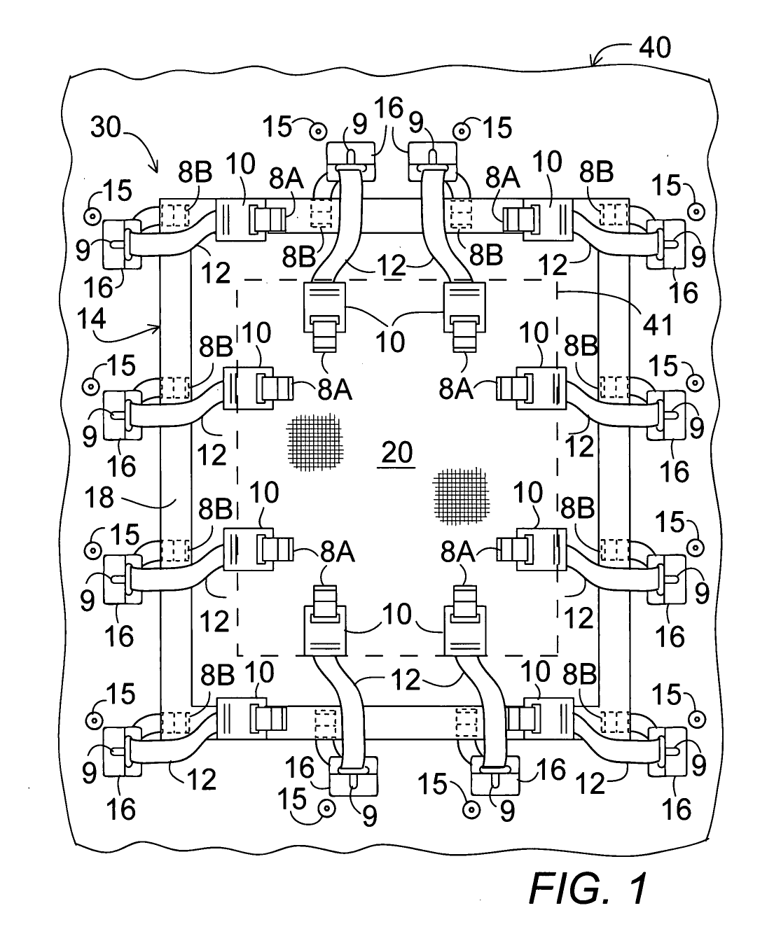

In FIGS. 1-6, a failsafe adjustable hurricane screen and attachment system 30 comprises a screen material 14 attached to cover an opening 41in a building 40 by straps 12 from the screen material through anchor brackets 16 removably secured to pre-attached fasteners 15 on the building and adjacent to the building with the straps tensioned by buckles 10 to secure the anchor brackets and tension the screen material.

A wind abating flexible sheet of screen material 14 is stretched out flat in tension for use as a wind abatement screen and rolled or folded up for storage. The screen material 14, preferably at least 20 Mil Polypropylene fabric material that is strong and durable and resistant to ultraviolet rays, and has a designated wind force resistance rating, preferably at least to resist 170 MPH winds. The screen material has a folded over hem 18 around the edges thereof, the hem preferably sewn with a Polyester and/or polytetrafluoroethylene (PTFE) thread to resist environmental conditions.

A plurality of anchor brackets 16 anchor the screen material 14 to cover at least one opening 41 in a building 40. Each anchor bracket 16 comprising means for removably attaching the anchor bracket to a protruding fastener 15 pre-attached to an external surface 40 around the at least one opening 41 in the building 40, preferably a T-shaped slot 9 on a flat face 5 of the anchor bracket contacting the surface to which the fastener 15 is attached. Each of the anchor brackets 16 comprises means to receive strapping material wound through the anchor bracket, such as a strap slot 7 in the anchor bracket preferably on a protruding flange 6 of the anchor bracket, wherein the strap slot 7 may communicate with the T-shaped slot 9 for attaching to the fastener 15. The T-shaped slot 9 in the anchoring bracket 16 has a wide opening contiguous with the strap slot 7 on the protruding flange 6 to receive the head of the fastener 15 therein and a narrow perpendicular slot extending away from the wide opening to receive and secure a shaft of the fastener therein when the anchoring bracket is pulled toward the screen by tension in the strap 12. Each of the anchor brackets 16 and fasteners 15 having a force resistance strength greater than the designated wind force resistance rating of the screen material. The anchor brackets are preferably stainless steel brackets with are configured in a variety of different shapes for use in different locations on the building and adjacent to the building, as shown in FIG. 3.

The adjustable buckles 10 are each attached by a strap 8A by sewing with Polyester and/or polytetrafluoroethylene (PTFE) thread on an interior portion of the screen material inward of the edge of the screen material on an outer face thereof facing away from the building, each buckle comprise means for receiving strapping material wound through the buckle and means for adjusting the tension of the strapping material within the buckle as used in standard buckles with straps. The buckles 10 are preferably metal cam buckles, which may be cast aluminum or zinc. The buckles 10 are positioned in opposing pairs around the screen material to distribute the tension evenly over the screen material.

The tie down straps 12 each comprise an elongated flat strap 12 resistant to wind forces greater than the designated wind force resistance rating of the screen material. A first end 8B (shown dashed) of the strap i12 s affixed to a portion of the hem 18 on an inner face of the screen material facing the building in alignment with a buckle 10 attached to the outer face of the screen facing away from the building. Each of the straps 12 is wound through one of the anchor brackets 16 and wound through one of the adjustable buckles 10 to form a failsafe adjustable hurricane screen and attachment system, so that the screen material is removably secured over the at least one opening 41 in the building 40 by attaching each anchor bracket 16 to each fastener 15 and tightening each of the means for tensioning the strapping material in the buckle 10 to tension the screen material 14 so that the screen material provides wind abatement for the building up to the designated wind force resistance rating of the screen material and if the wind force or object impact force exceeds the designated wind force resistance rating of the screen material, the screen material will fail before any of the other elements of the system preventing damage to the building by leaving the fasteners intact. The screen material further comprises a tear resistance rating so that the screen material will tear and still perform at the designated resistance rating.

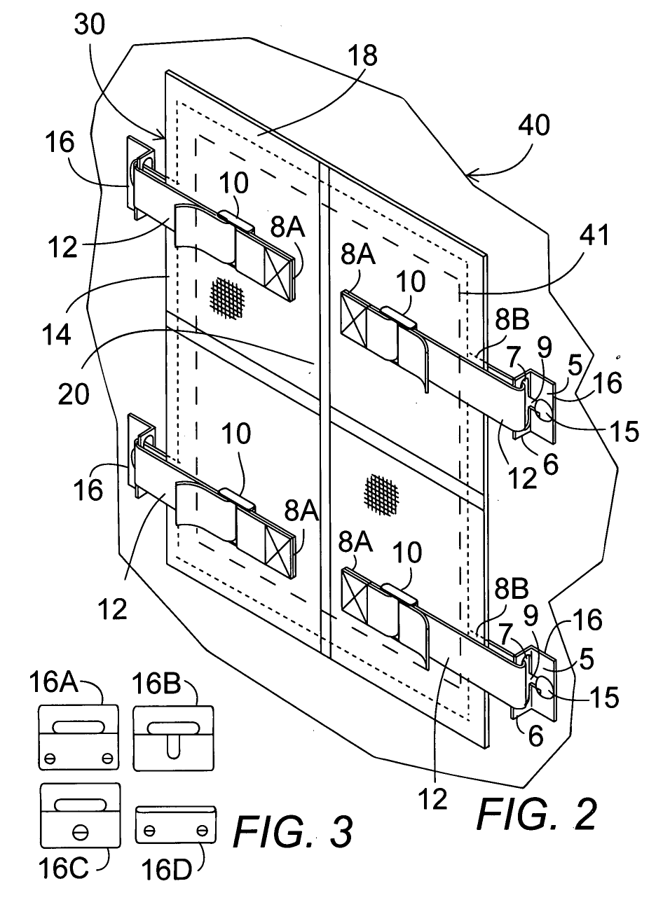

In FIGS. 1 and 2, the buckles 10 are connected to the screen 14 by strap ends 8A between the edge and the middle on the front side. The matching straps 12 are connected at strap ends 8B on the back side toward the edge on the hem 18. The strap 12 loops though the bracket 16 which is mounted around the structures opening and back towards and connecting through the buckle 10.

On the opposite side of the opening an opposing bracket 16, strap 12 and buckle 10 pull the screen 14 in an opposite direction creating taught conditions on the edges and in the “core/center 20 of the screen. The bracket 16, buckle 10, and strap 12 assemblies and the opposing bracket 16, buckle 10 and strap 12 assemblies are repeated around the screen 14 dispersing the potential wind load of storm among the assemblies to acceptable limits dictated by the bracket 16, buckle 10, strap 12, and screen 14 assembly load capabilities.

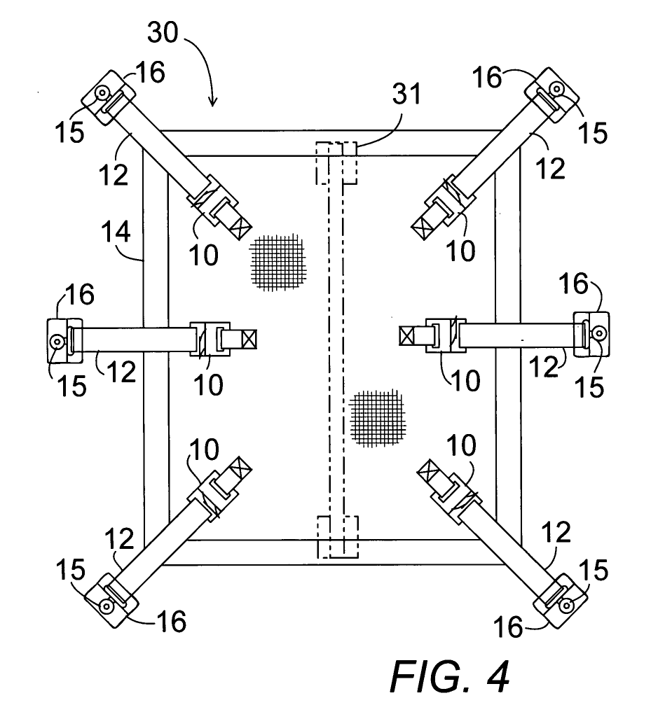

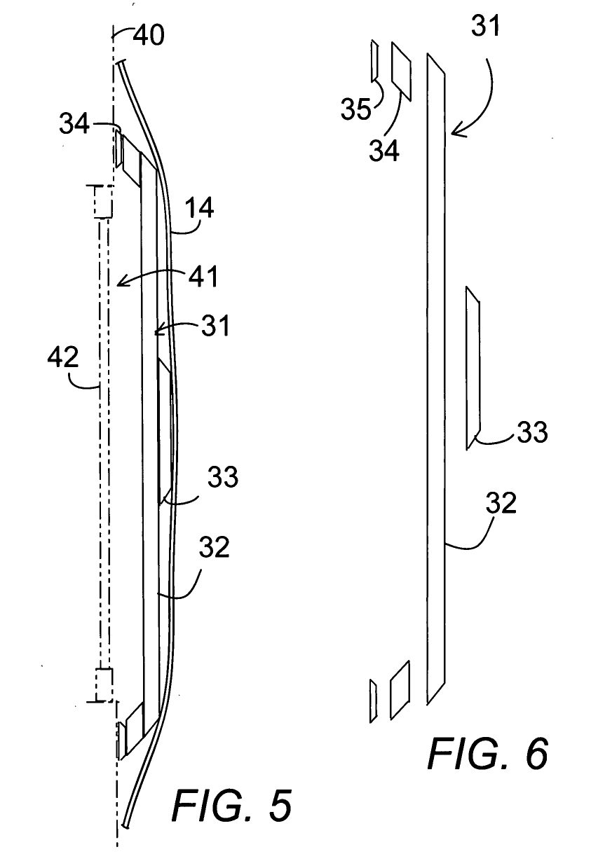

In FIGS. 5 and 6, an optional storm bar 31 is attached to the outside wall of the building 40 under the screen material 14 across a window opening 41 to keep the screen material 14 away from a window pane 42 located close to the outer face of the wall of the building. The storm bar 31 comprises a rigid square tubular long bar 32 has an attached outer center bar 33 holding the middle of the screen material away from the window pane 42. Angle tubular legs 34 elevate the long bar 32 away from the building, and polycarbonate pads 35 attached to the building under the legs 34. The storm bar 31 may be fabricated of aluminum or other metal or fiberglass or plastic tubing for lightweight strength. The storm bar 31 may be oriented vertically on a window with anchors on the sides and corners of the window, as in FIG. 4.

In FIG. 6 the components of the storm bar 31 are aligned for assembly.

In use, the brackets are connected around the structure's opening. The adjustable hurricane screen is stored for future use. Prior to a hurricane or wind storm the adjustable hurricane screens are removed from storage and matched to each corresponding structural opening. The back of the screen is placed towards the structure. All the straps of the adjustable hurricane screen are looped through the brackets and around towards the front of the screen entering and connecting through the buckles. The screen is centered by adjusting the straps and opposing straps length between the buckles and bracket. As the straps are tightened, the bracket acts as a fulcrum pulling between the edge and the “core/center” of the screen against the opposing strap and buckle assembly with equal force creating a uniformed taught condition.

The anchors/mounting surface hold 1600 Lbs Max. The screen holds 1300 Lbs Max so that the screen will tear before the anchors/mounting fail, thereby providing a fail-safe system wherein the screen will give out before the attaching anchors under extreme wind conditions so that the building will not be damaged by the screen. The screen will hold 600 Lbs after tearing. The anchors/mounting are designed for less than 400 Lbs. The hem will hold 2000 Lbs.

The fail-safe adjustable hurricane screen of the present invention is fabricated of 20 Mil Polypropylene fabric material that is strong and durable and resistant to ultraviolet rays. It is easy to put up, will always fit, and can withstand hurricane force winds. The 138 Polyester and/or polytetrafluoroethylene (PTFE) thread used on the screen of the present invention is a 15-20 lb test thread. The PTFE thread is not affected by moister or ultraviolet ray like Nylon which is stronger but breaks down with moister and ultraviolet rays. A screen made with nylon has a much less effective life span than polyester (becomes worthless). The present invention uses 1½″ Polyester webbing rated at 1200 Lb. This means with 10 attachments will have a webbing rating of 2500 lbs. Polyester is ultraviolet resistant and is not affected by moister like nylon. The present invention uses 1½″ aluminum cast cam-lock buckles rated at 1200 lb which are spring loaded and have an aggressive bite pattern to eliminate the slipping problem other hurricane companies have ignored with cheap plastic buckles. A screen with 10 attachments will have a buckle rating of 12000 lbs. Some other hurricane companies rely on grommets which have no ratings.

The hurricane screen hardware is self contained. A single user simply threads webbing through attachment and buckle, then pulls taught.

The strength and durability of fabric hurricane screens depend greatly on the thickness of the screen itself. The tensile strength is the crucial number that determines how much grip a material can handle. For example if you were pulling yourself in a tree by a stick the size of a pencil it would probably break. Now if you were to pull yourself in a tree by a stick the size of a baseball bat it probably would not break. The testing method uses a grab method (ASTM D 4632) The warp, (yarns running lengthwise) and the fill, (yarns running crosswise, and at right angle to the warp) to determine the failure point. The amount of grab is 1 inch. and the force need to initiate a failure is in lbs. Thickness determines tensile strength, a 20 mil material has a tensile strength warp (lengthwise) at 500 lbs and a 12 mil material might then only have a tensile strength of 265 lbs. Thicker is better.

The amount of grab is the second crucial facture. Try to hold yourself up on that stick with two fingers and a thumb. Four fingers work much better because you can distribute your weight better. If a screen had a Tensile strength of 500 lbs, grabbing that 20 mil at ½ inch length, a failure will occur at 250 lbs. Grabbing at 2″ length, a failure will occur at 1100 lbs. Longer is Better.

Tear strength is the amount of force needed to extend an existing tear. Once again thicker is better

The strap of the present invention has a surface area of 3.75″. Grab area to the fill (crosswise of warp) 1.5″+and warp (lengthwise) 5″. Since strap and buckles are connected together the load will be reduced in half. The buckle carrying one half, the straps the other but are not reflected in the chart Zinc cam buckles unlike plastic buckles do not slip even when wet & under load. Gortex/Tanara sewn attachments are guaranteed by Gore to last the lifetime of the fabric. The thread is unaffected by UV rays, Moisture, Mold, Mildew and retains the same strength as the day tested. Polyester thread can quickly looses strength from UV and moisture so that Polyester thread's testing strength diminishes with time.

In the present invention, 304 Stainless steel brackets are the self contained attaching hardware so there is nothing to loose. The slotted bracket allows extremely quick deployment. The present system has excellent visual curb appeal with only a minimum of anchors and screws left in wall when not deployed. The screens come in multiple colors including tan, black, grey, white and beige.

The present invention uses a specially designed bracket system that allows the screen to be attached to the inside of the window well, on the outside of build-outs, on the face of a wall, or over decorative shutters. These plates are low profiled and made from stainless steel for extreme durability. The screens of the present invention can be customized for unique structure openings.

The present invention provides two styles of garage door screens. The four point garage door screen attaches to the three sides of the garage and then tents out an additional twelve inches to the cement driveway for maximum strength and deflection. The three point garage door screen attaches to the sides of the garage door. This design utilizes a specially designed buckles-and-strap system that allows an excellent level of protection and deflection against hurricanes without the need to connect to a fragile or non-supportive driveway material. The Lanai screens are cascaded together to cover large openings. The screens can be segmented in ten foot, our screens are much more manageable than the forty foot monsters the other companies make. The screens of the present invention are much more affordable than other shutters, and provide a much greater level of home defense in comparison to other hurricane screen products.

The screens of the present invention block 97% of the wind, debris, and rain and have been tested and approved by the State of Florida to prevent damage caused by winds up to 170 mph (Hurricane Category 5).

It is understood that the preceding description is given merely by way of illustration and not in limitation of the invention and that various modifications may be made thereto without departing from the spirit of the invention as claimed.

What is claimed is:

1. A failsafe adjustable hurricane screen and attachment system comprising:
a wind abating flexible sheet of screen material stretched out flat in tension for use as a wind abatement screen and rolled or folded up for storage, the screen material having a designated wind force resistance rating, the screen material having a folded over hem around the edges thereof;
a plurality of anchor brackets for anchoring the screen material to cover at least one opening in a building, each anchor bracket comprising means for removably attaching the anchor bracket to a protruding fastener pre-attached to an external surface around the at least one opening in the building and each of the anchor brackets comprising means to receive strapping material wound through the anchor bracket, each of the anchor brackets and fasteners having a force resistance strength greater than the designated wind force resistance rating of the screen material;
a plurality of adjustable buckles each attached to an interior portion of the screen material inward of the edge of the screen material on an outer face thereof facing away from the building, each buckle comprising means for receiving strapping material wound through the buckle and means for adjusting the tension of the strapping material within the buckle;
a plurality of tie down straps, each strap comprising an elongated flat strap resistant to wind forces greater than the designated wind force resistance rating of the screen material with a first end affixed to a portion of the hem on an inner face of the screen material facing the building, each of the straps wound through one of the anchor brackets and wound through one of the adjustable buckles to form a failsafe adjustable hurricane screen and attachment system, so that the screen material is removably secured over the at least one opening in the building by attaching each anchor bracket to each fastener and tightening each of the means for tensioning the strapping material to tension the screen material so that the screen material provides wind abatement for the building up to the designated wind force resistance rating of the screen material and if the wind force or object impact force exceeds the designated wind force resistance rating of the screen material, the screen material will fail before any of the other elements of the system preventing damage to the building by leaving the fasteners intact and the screen material further comprises a tear resistance rating so that the screen material will tear and still perform at the designated resistance rating.

2. The system of claim 1 wherein the means for removably attaching the anchoring bracket to the protruding fastener comprises a T-shaped slot in the anchoring bracket with a wide opening to receive a head of the fastener therein and a narrow perpendicular slot extending away from the wide opening to receive and secure a shaft of the fastener therein when the anchoring bracket is pulled toward the screen by tension in the strap.

3. The system of claim 1 wherein the buckles are metal cam buckles.

4. The system of claim 3 wherein the buckles are cast aluminum.

5. The system of claim 3 wherein the buckles are fabricated of zinc.

6. The system of claim 1 wherein the screen material is at least 20 Mil Polypropylene fabric material that is strong and durable and resistant to ultraviolet rays.

7. The system of claim 1 wherein the hem around the edge of the material is secured by sewing overlapping screen material with a Polyester thread.

8. The system of claim 1 wherein the hem around the edge of the material is secured by sewing overlapping screen material with a Polytetrafluoroethylene thread.

9. The system of claim 1 wherein the buckles are attached to the screen material by a strip of strap sewn to the screen material with a Polyester thread.

10. The system of claim 1 wherein the buckles are attached to the screen material by a strip of strap sewn to the screen material with a Polytetrafluoroethylene thread.

11. The system of claim 1 wherein the ends of the straps are attached to the hem of the screen material of the inner side of the screen material by a Polyester thread.

12. The system of claim 1 wherein the ends of the straps are attached to the hem of the screen material of the inner side of the screen material by a Polytetrafluoroethylene thread.

13. The system of claim 1 wherein the anchor brackets are stainless steel brackets.

14. The system of claim 1 wherein the anchor brackets are configured in a variety of different shapes for use in different locations on the building and adjacent to the building.

15. The system of claim 1 further comprising a storm bar comprising an elongated rigid long bar elevated on legs attached to a building across a building opening to hold the screen material away from a window pane in the opening.
